(19) United States
(12) Patent Application Publication
(10) Pub. No.: US 2026/0277170 A1
(43) Pub. Date: Sep. 17, 2026

(54) SYSTEMS AND METHODS FOR AN AUTOMATION ECOSYSTEM

(71) Applicant: Ford Global Technologies, LLC, Dearborn, MI (US)

(72) Inventors: Alexandra Alioto, Bloomfield Hills, MI (US); Russell Andres, Riverview, MI (US)

(73) Assignee: Ford Global Technologies, LLC, Dearborn, MI (US)

(21) Appl. No.: 19/076,733

(22) Filed: Mar. 11, 2025

(51) Int. Cl. G05B 11/32

(52) U.S. Cl. CPC G05B 11/32

(57) ABSTRACT

Systems and methods for an automation ecosystem are provided. The system may include one or more primary devices such automation cloud server, one or more vehicles, one or more mobile devices, and one or more facilities. Each of the primary devices may control one or more secondary devices. An automation routine is created and has a unique automation identifier and has associated one or more trigger conditions. The automation routine is saved in the local memory of each device in the ecosystem upon generation. Upon the one or more trigger conditions being satisfied, the automation cloud server automatically initiates execution of the associated routine and sends the automation routine identifier to the appropriate devices. The devices receive the automation routine identifier and execute the automation routine. After execution, each of the primary devices sends a status update to the automation cloud server.

### FIELD

The present disclosure relates to the field of automation. Specifically, embodiments of the present disclosure relate to methods and systems for creating and running an automation ecosystem that may include an automation cloud server, user mobile devices, one or more vehicles, and/or a plurality of devices within a facility.

### BACKGROUND

Smart configuration in vehicles refers to the use of advanced technologies to personalize and optimize a vehicle's settings, performance, and user experience. It involves artificial intelligence (AI), Internet of Things (IoT), cloud computing, and automation to provide customized and adaptive driving solutions. Automation in vehicles is currently limited to configuring and controlling vehicle features such as seat position, climate control, infotainment preferences, driving modes, and ambient lighting.

Current vehicle automation systems are limited to hardware and software within the vehicle and do not have the ability to connect to other smart systems/third-party devices outside the vehicle. In addition, these automation features can only be controlled and triggered from within the vehicle.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an environment in which embodiments of the present disclosure can be implemented.

FIG. 2 illustrates a block diagram of a vehicle according to an embodiment of the present disclosure.

FIG. 3 illustrates a process flow for creating an automation routine according to an embodiment of the present disclosure.

FIG. 4 illustrates an example of an automation routine structure and how each of the devices in the automation ecosystem receives the automation routine according to an embodiment of the present invention.

FIGS. 5A and 5B illustrate examples of how the automation routine information is stored within the ecosystem devices according to an embodiment of the present invention.

FIG. 6 illustrates a flow diagram for a process for executing an automation routine according to an embodiment of the present disclosure.

FIG. 7 illustrates a scenario in which multiple devices act as trigger devices and the automation routine is executed by multiple devices of the ecosystem according to another embodiment of the present disclosure.

FIG. 8 illustrates an example of an automation routine according to an embodiment of the present disclosure.

FIG. 9 illustrates a process for executing the automation routine of FIG. 8 according to an embodiment of the present disclosure.

FIG. 10 illustrates an example of an automation routine according to yet another embodiment of the present disclosure.

FIG. 11 illustrates a process for executing the automation routine of FIG. 10 according to yet another embodiment of the present disclosure.

FIG. 12 illustrates a block diagram of an automation cloud server according to an embodiment of the present disclosure.

### DETAILED DESCRIPTION

### Overview

The present disclosure describes systems and methods for automation. Specifically, embodiments of the present disclosure relate to systems and methods for an automation ecosystem.

Embodiments of the present disclosure provide a method. The method may include determining whether one or more trigger conditions are satisfied. The one or more trigger conditions may be associated with an automation routine. The method further may include determining, based on the one or more trigger conditions being satisfied, an automation routine identifier associated with the automation routine and sending the automation routine identifier to one or more primary devices. The method further may include determining, by the one or more primary devices, one or more actions associated with the automation routine, operating, by the one or more primary devices and based on the one or more actions, one or more secondary devices communicably coupled to the one or more primary devices to, and receiving, from the one or more primary devices, a status update associated with execution of the automation routine. The method further may include receiving information about the one or more trigger conditions, receiving information about the one or more actions, determining, based on the one or more actions, the one or more primary devices, generating the unique automation routine identifier, generating the automation routine; wherein the automation routine may include the one or more trigger conditions, the one or more actions, and information about the one or more primary devices, and assigning the automation routine identifier to the automation routine.

In another instance, a method is provided that may include receiving information about the one or more trigger conditions, receiving information about the one or more actions, and determining, based on the one or more actions, one or more primary devices. The method further may include determining, based on the one or more actions, one or more secondary devices, wherein the secondary devices are associated with the one or more primary devices, generating the unique automation routine identifier, generating the automation routine; wherein the automation routine may include the one or more trigger conditions, the one or more actions, and information about the one or more primary devices, assigning the automation routine identifier to the automation routine, and sending the automation routine to the one or more primary devices. The method further may include receiving information that the one or more trigger conditions are satisfied, sending the automation routine identifier to the one or more primary devices, determining, by the one or more primary devices, the automation routine based on the automation routine identifier, and executing, by the one or more primary devices, the automation routine.

In yet another instance, a system is provided that may include a first device and a second device communicably coupled to the second device. The system may further include one or more third devices communicably coupled to the first device or the second device, and a memory device that stores instructions, which when executed by a processor of the first device, cause the processor to (i) determine that one or more trigger conditions are satisfied, wherein the one or more trigger conditions are associated with an automation routine, (ii) determine, based on the one or more trigger conditions being satisfied, an automation routine identifier associated with the automation routine, (iii) send the automation routine identifier to the second device, (iv) cause the second device to perform a first set of actions associated with the automation routine, (v) perform a second set of actions associated with the automation routine, and (vi) receive, from the second device, a status update associated with execution of the automation routine. The system may further receive information about the one or more trigger conditions, receive information about the first set of actions, determine, based on the first set of actions, the second device, generate the automation routine identifier, generate the automation routine; wherein the automation routine may include the one or more trigger conditions, the first set of actions, and assign the automation routine identifier to the automation routine.

These and other advantages of the present disclosure are provided in detail herein.

### Illustrative Embodiments

The disclosure will be described more fully hereinafter with reference to the accompanying drawings, in which example embodiments of the disclosure are shown and not intended to be limiting.

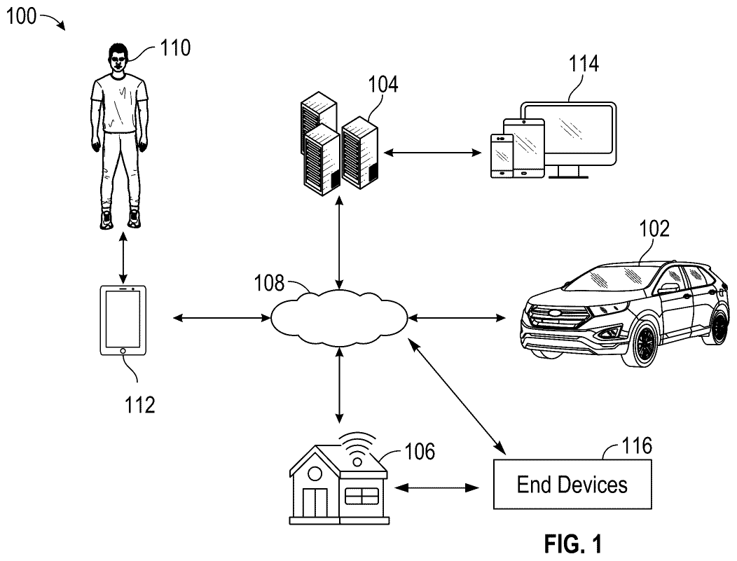

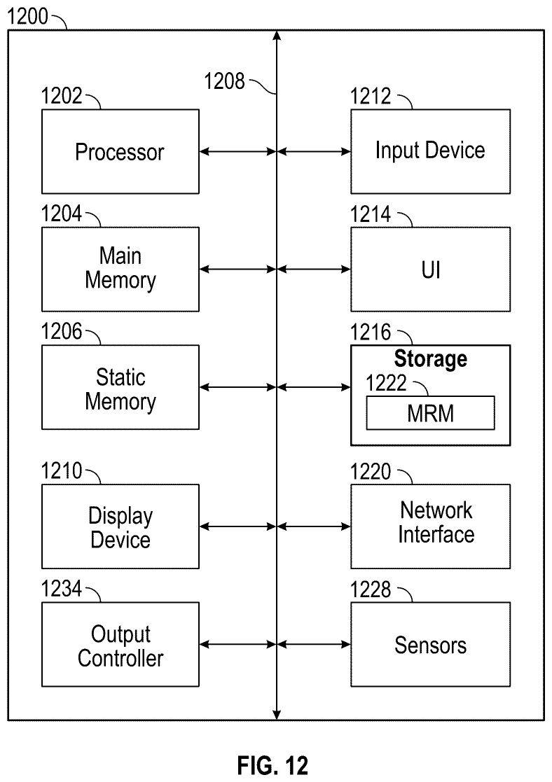

FIG. 1 illustrates an environment/ecosystem 100 in which the embodiments of the present disclosure may be implemented. The ecosystem 100 may include one or more vehicles 102. Although only a single vehicle 102 is illustrated in FIG. 1, it is to be understood that multiple vehicles 102 can be part of the ecosystem 100. The vehicle 102 can be any passenger or commercial vehicle such as a car, truck, tanker, bus, or the like. The ecosystem 100 may also include a control server/automation cloud server 104. The automation cloud server 104 may be part of a cloud-based computing infrastructure and may be associated with and/or include a Telematics Service Delivery Network (SDN) that provides digital data services to the vehicle 102. Details of the automation cloud server 104 are provided below with reference to FIG. 12.

The ecosystem 100 may also include a user device 112. The user device 112 may be one of a mobile phone, a tablet, a personal computer, a smart key fob, or the like. The user device 112 may be associated with a user 110 of the vehicle 102. The user 110 may be a driver of the vehicle 102 or a passenger in the vehicle 102. The user device 112 may receive information from the vehicle 102 and/or the control server 104. The user device 112 may have a specialized application installed on it that can interface with the vehicle 102 to download and display various types of vehicle-generated information and other control data. In one embodiment, the vehicle 102 may communicate directly with the user device 112 to send and receive data without the need for the network 108 and/or the server 104. The ecosystem 100 may include multiple user devices 112—even though only a single user device 112 is shown for sake of simplicity. Each user device 112, of the multiple user devices, may be associated with a unique user.

The ecosystem 100 may further include a network 108. The network 108 illustrates an example communication infrastructure in which the connected devices discussed in various embodiments of this disclosure may communicate. The network 108 may be and/or include the Internet, a private network, public network, or other configuration that operates using any one or more known communication protocols such as, for example, transmission control protocol/Internet protocol (TCP/IP), Bluetooth®, Bluetooth® Low Energy (BLE), Wi-Fi based on the Institute of Electrical and Electronics Engineers (IEEE) standard 802.11, ultra-wideband (UWB), and cellular technologies, such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The ecosystem may also include a facility controller 106. The facility controller 106 may include an edge computing device/facility controller (not shown) that is communicably coupled to the automation cloud server 104, the user device 112, the vehicle 102, and one or more end devices/secondary devices 116 associated with the house. The one or more end devices 116 may include, but are not limited to, smart speakers, smart displays, smart bulbs, smart light switches, connected cameras and other sensors, smart doorbells, smart locks, smart alarms, smart thermostats, smart HVAC systems, smart appliances, smart TVs, streaming devices, smart plugs and outlets, smart scales, smart fitness equipment, smart cleaning devices, smart sprinklers and lawn mowers, smart chargers, etc. In an embodiment, the end devices 116 may be Internet of Things (IoT) enabled devices. The facility controller 106 may be located in a facility. The facility may include a single-family home, multi-family home, apartments, condominium, townhouses or row houses, mobile home, modular home, a warehouse, a factory, a commercial establishment, or the like. In an embodiment, the facility controller 106 may be communicably coupled to some or all the end devices 116. In some embodiments, a subset of the end devices 116 may be part of a home network managed and/or controlled by the facility controller 106. The facility controller device may be an edge computing device programmed with custom instructions to execute automation routines based on information received from the automation cloud server 104. The facility controller 106 may also provide information to the automation cloud server 104 about one or more trigger conditions associated with the facility being met. In an embodiment, each of the automation cloud server 104, the vehicle 102, and the mobile device 112 may control a set of end devices 116 that are communicably coupled to them. For example, the vehicle 102 may include several vehicle features that it can control such a doors, windows, climate control system, etc. The facility controller 106 may control lights, doors, thermostats, appliances, etc. associated with the facility. All such devices are referred to as “end devices” or “secondary devices” in this disclosure. Further, the automation cloud server 104, the vehicle 102, the facility controller 106, and the mobile device 112 may be referred to as the “primary” devices of the ecosystem 100.

The ecosystem 100 may further include an input/output device 114. The input/output device may be a personal computer, a mobile device such as a phone or a tablet, a voice-enabled input device, a braille-enabled device, or the like. In some embodiments, the user device 112 or the vehicle 102 may also be used as the input/output device 114. The input/output device 114 may be used to interact with the automation cloud server 104 to provide information that may be used by the automation cloud server 104 to generate an automation routine as explained below. In other embodiments, the input/output device 114 may be used to provide information to the operator of the automation cloud server 104 such as notifications or alerts.

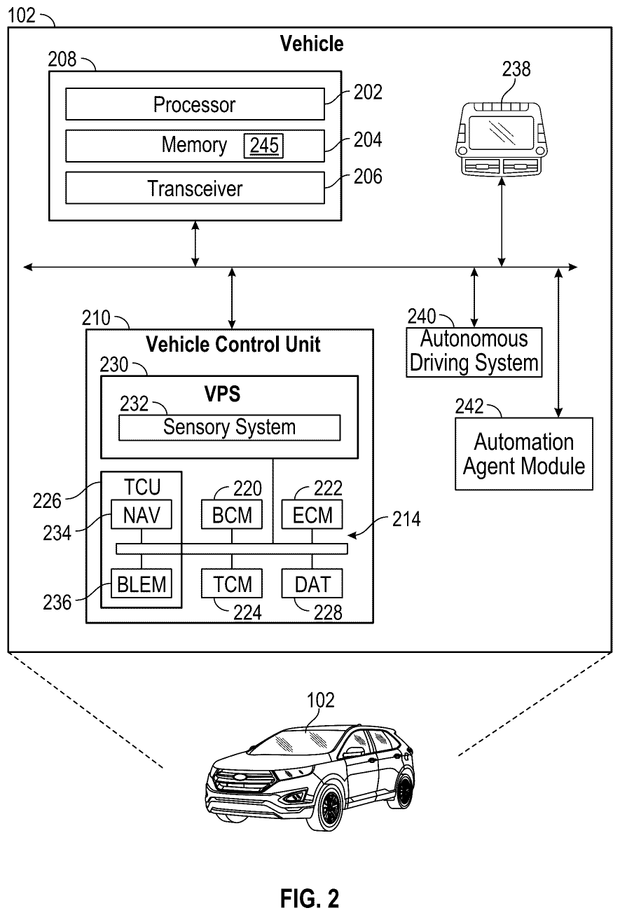

The vehicle 102 may include a plurality of units including, but not limited to, an automotive computer, a Vehicle Control Unit (VCU), and an automation agent. Details of the vehicle 102 are provided below in reference to FIG. 2.

FIG. 2 illustrates a block diagram of the vehicle 102 in which embodiments of the present disclosure can be implemented. The vehicle 102 may include a plurality of units including, but not limited to, an automotive computer 208, a Vehicle Control Unit (VCU) 210, and an infotainment unit 238. The VCU 210 may include a plurality of Electronic Control Units (ECUs) 214 that are in communication with the automotive computer 208.

In some embodiments, a user device, such as a mobile phone, a laptop computer, a smart fob, or the like, may be configured to connect with the automotive computer 208, which may communicate via one or more wireless connection(s), and/or may connect with the vehicle 102 directly by using near field communication (NFC) protocols, Bluetooth® protocols, Wi-Fi, Ultra-Wideband (UWB), and other possible data connection and sharing techniques.

The automotive computer 208 may be installed anywhere in the vehicle 102, in accordance with the disclosure. The automotive computer 208 may be or include an electronic vehicle controller, having one or more processor(s) 202, one or more memory devices 204, and one or more transceivers 206.

The processor(s) 202 may be disposed in communication with one or more memory devices that are in communication with the respective computing systems (e.g., the memory 204 and/or one or more external databases not shown in FIG. 2). The processor(s) 202 may utilize the memory 204 to store programs in code and/or to store data for performing operations in accordance with the disclosure. The memory 204 may be a non-transitory, computer-readable storage medium or memory storing a vehicle control program code. The memory 204 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.). In some embodiments, memory 204 may include a module 245 that can implement the various embodiments of the present disclosure. Module 245 may include instructions that can be executed by the processor 202 to realize the various embodiments of the present disclosure.

Automotive computer 208 may also include a transceiver 206. The transceiver 206 may be configured to receive information/inputs from one or more external devices or systems, e.g., a user device 208, an external server, and/or the like. Further, the transceiver 206 may transmit notifications, requests, signals, etc., to the external devices or systems. In addition, the transceiver 206 may be configured to receive information/inputs from vehicle components such as the vehicle sensory system 232, one or more ECUs 214, and/or the like. Further, the transceiver 206 may transmit signals (e.g., command signals) or notifications to the vehicle components such as the BCM 220, the infotainment system 238, and/or the like.

In some embodiments, the VCU 210 may share a power and/or communications bus with the automotive computer 208 and may be configured and/or programmed to coordinate the data between vehicle systems, connected servers, and/or the like. The VCU 210 may include or communicate with any combination of the ECUs 214, such as, for example, the BCM 220, an Engine Control Module (ECM) 222, a Transmission Control Module (TCM) 224, a Telematics Control Unit (TCU) 226, a Driver Assistance Technologies (DAT) controller 228, etc. The VCU 210 may further include and/or communicate with a Vehicle Perception System (VPS) 230, having connectivity with and/or control of one or more vehicle sensory system(s) 232. The vehicle sensory system 232 may include one or more vehicle sensors including, but not limited to, a Radio Detection and Ranging (RADAR or “radar”) sensor configured for detection and localization of objects inside and outside the vehicle 102 using radio waves, sitting area buckle sensors, sitting area sensors, a Light Detecting and Ranging (“LIDAR”) sensor, door sensors, proximity sensors, temperature sensors, wheel sensors, one or more ambient weather or temperature sensors, vehicle interior and exterior cameras, steering wheel sensors, etc. The sensors that are part of the vehicle sensory system 232 may be coupled to the vehicle 102 at one or more locations and in one or more configurations. For example, the various sensors of the vehicle sensory system 232 may be integrated into the various subsystems of the vehicle 102, such as doors, mirrors, roof, etc. or attached to the vehicle 102 using an appropriate mounting mechanism. In some embodiments, the various sensors of the vehicle sensory system 232 may be located at the front, back, sides, top, bottom, and underneath the vehicle 102. The location of a sensor may depend on its function. For example, a sensor that monitors the area underneath the vehicle may be connected to a bottom surface of the vehicle 102, while a sensor that can monitor an area to any side of the vehicle 102 may be mounted or integrated into the doors of the vehicle 102. Vehicle sensory system 232 may also include one or more road noise sensors, such as accelerometers that are coupled to various mechanical components and/or systems of the vehicle 102. One skilled in the art will realize that the sensors may be coupled with the vehicle in various ways and locations other than the ones mentioned above.

In some embodiments, the VCU 210 may control vehicle operational aspects and implement one or more instruction sets received from the server 104, the user device 112, or from one or more instruction sets stored in the memory 204.

The TCU 226 may be configured and/or programmed to provide vehicle connectivity to wireless computing systems onboard and offboard the vehicle 102 and may include a Navigation (NAV) receiver 234 for receiving and processing a GPS signal, a BLE® Module (BLEM) 236, a Wi-Fi transceiver, a UWB transceiver, and/or other wireless transceivers (not shown in FIG. 2) that may be configurable for wireless communication (including cellular communication) between the vehicle 102 and other systems (e.g., a vehicle key fob (not shown in FIG. 2), an external server, a user device, etc.), computers, and modules. The TCU 226 may be in communication with the ECUs 214 by way of a wired or wireless bus. In some aspects, the TCU 226 may be configured to determine a real-time vehicle geolocation, e.g., via the NAV receiver 234.

The ECUs 214 may control aspects of vehicle operation and communication using inputs from human drivers, inputs from the automotive computer 208, and/or via wireless signal inputs received via the wireless connection(s) from other connected devices, such as the server 104 among others.

The BCM 220 generally includes integration of sensors, vehicle performance indicators, and variable reactors associated with vehicle systems and may include processor-based power distribution circuitry that may control functions associated with the vehicle body such as lights, windows, security, camera(s), audio system(s), wipers, door locks and access control, various comfort controls, etc. The BCM 220 also may operate as a gateway for bus and network interfaces to interact with remote ECUs (not shown in FIG. 2).

The DAT controller 228 and/or the autonomous driving system 240 may provide Level-1 through Level-5 automated driving and driver assistance functionality that may include, for example, active parking assistance, vehicle backup assistance, and/or adaptive cruise control, among other features. The DAT controller 228 also may provide aspects of user and environmental inputs that are usable for user authentication.

In some embodiments, the automotive computer 208 may connect with an infotainment system 238 (or a vehicle Human-Machine Interface (HMI)). The infotainment system 238 may include a touchscreen interface portion and voice recognition features, biometric identification capabilities that may identify users based on facial recognition, voice recognition, fingerprint identification, or other biological identification means. In other aspects, the infotainment system 238 may be further configured to receive user instructions via the touchscreen interface portion and/or output or display notifications, navigation maps, etc. on the touchscreen interface portion. In some embodiments, the user device 112 may provide the HMI interface.

The computing system architecture of the automotive computer 208 and/or the VCU 210 may omit certain computing modules. It should be readily understood that the computing environment depicted in FIG. 2 is an example of a possible implementation according to the present disclosure, and thus, it should not be considered as limiting or exclusive.

The vehicle 102 may further include an automation agent module 242. In an embodiment, the automation agent may be a software module or a combination of hardware and software. For example, the automation agent may be an edge computing device that is programmed with specialized instructions that enable the automation agent to receive instructions from the automation cloud server 104 and execute an automation routine based on the instructions. In other embodiments, the automation agent module 242 may provide instructions to other devices in the ecosystem 100 causing those devices to execute one or more automation routines. In an embodiment the automation agent module 242 may include one or more processors (e.g., CPU, GPU, ASIC, FPGA, etc.), one or more memory devices (e.g., volatile, and nonvolatile memory devices), one or more input/output ports, network interfaces. The automation agent module 242 may also include software components such as an operating system, edge AI and machine learning framework, containerization and virtualization software, security and encryption, edge middleware and APIs, etc. The automation agent module 242 may be programmed to carry out several automation routines based on information received from the automation cloud server 104 and/or the VCU 210. In an embodiment, the automation agent module 242 may store the details of the automation routines indexed using a unique automation identifier that is associated with each automation routine. In an embodiment, the automation agent module 242 may be integrated into the VCU 210.

In addition to the components noted above, the vehicle 102 may have numerous mechanical systems and sub-systems. A chassis, frame, or unibody may form the backbone of the vehicle 102 and support the body and other components of the vehicle 102. The vehicle 102 may include an engine that converts fuel into mechanical power, propelling the vehicle forward. The engine may include various components such as the engine block, pistons, valves, and spark plugs. The vehicle 102 also may include a transmission system. The transmission system transfers the engine's power to the wheels. It may include the clutch, gearbox, driveshaft, and differentials, among other components. The transmission adjusts the power output to suit the vehicle's speed and load. The vehicle 102 also may include a suspension system. The suspension system absorbs shocks and maintains contact between the tires and the road, providing a smooth ride. It may include components such as springs, shock absorbers, and linkages. The vehicle 102 also may include a vehicle-stopping system that allows the driver to slow down or stop the vehicle 102. It may include components like pedals, master cylinders, lines, and pads or shoes. The vehicle 102 also may include a steering system that enables the driver to guide the car. The steering system may include components such as the steering wheel, steering column, rack and pinion, and tie rods. The vehicle 102 may further include an exhaust system that removes and filters the waste gases produced by the engine. It may include the exhaust manifold, catalytic converter, muffler, and tailpipe, among other components. The vehicle 102 also may include a cooling system that prevents the engine and/or battery from overheating. It may include components such as the radiator, water pump, thermostat, and coolant. The vehicle 102 may also include a cooling system that stores and supplies fuel to the engine. It may include the fuel tank, fuel pump, fuel filter, and fuel injectors. An electrical system of the vehicle 102 powers the car's electrical components. It may include the battery, alternator, starter motor, and wiring. The Heating, Ventilation, and Air Conditioning (HVAC) system controls the temperature inside the vehicle 102. It may include the heater core, blower motor, and air conditioning compressor. In some embodiments, the vehicle may be an electric vehicle (EV) or hybrid vehicle, and in either case, some of the aforementioned components would be replaced by an electric motor and a high-voltage battery. All the mechanical components working together ensure that the vehicle 102 operates optimally.

The various devices of the ecosystem 100 are configured to create and run various automation routines based on predetermined trigger conditions being met. A “trigger condition” is occurrence of a specific event or action. For instance, opening of door or arrival of a vehicle at a specific location can be a trigger condition. These trigger conditions can be defined by the user 110 or may be suggested to the user 110 by any of the devices in the ecosystem 100 based on historical data and user behavior patterns. There are several ways in which an automation routine can be created. Further, the automation routines can be created using the input/output device 114, the user device 112, or the vehicle 102. Each of these devices may have an automation programming interface (e.g., an application, web interface, or the like) that the user can interact with to create an automation routine.

In order to create a routine, the user may provide several items of information to the automation cloud sever 104, via any of the devices mentioned above. The several items of information may include information about one or more trigger conditions, information about one or more devices that may be used to execute the automation routine, and one or more end devices 114 associated with the automation routine, and one or more actions to be performed by the associated end devices 114.

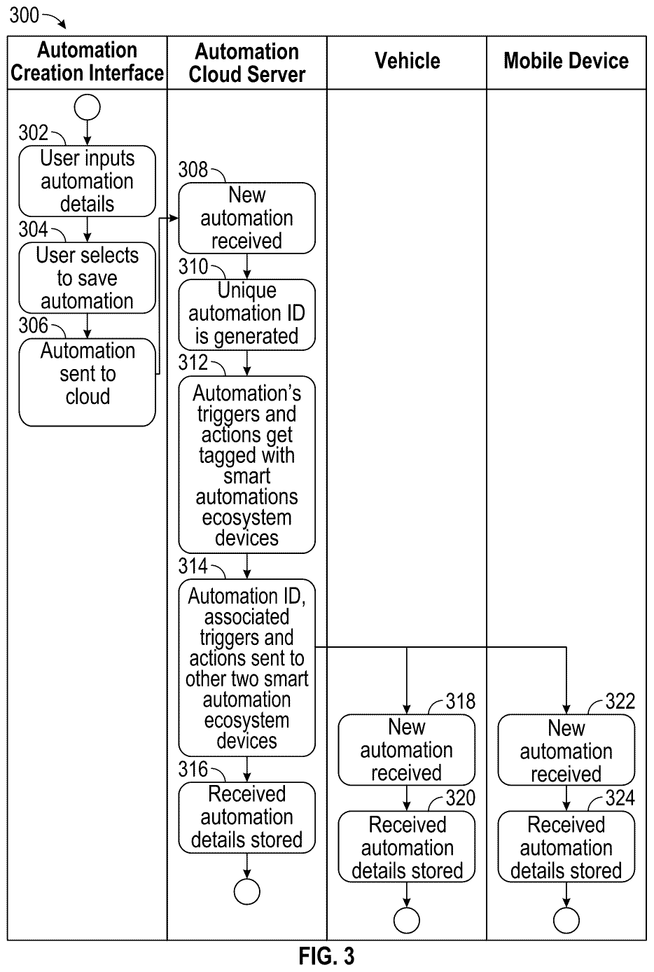

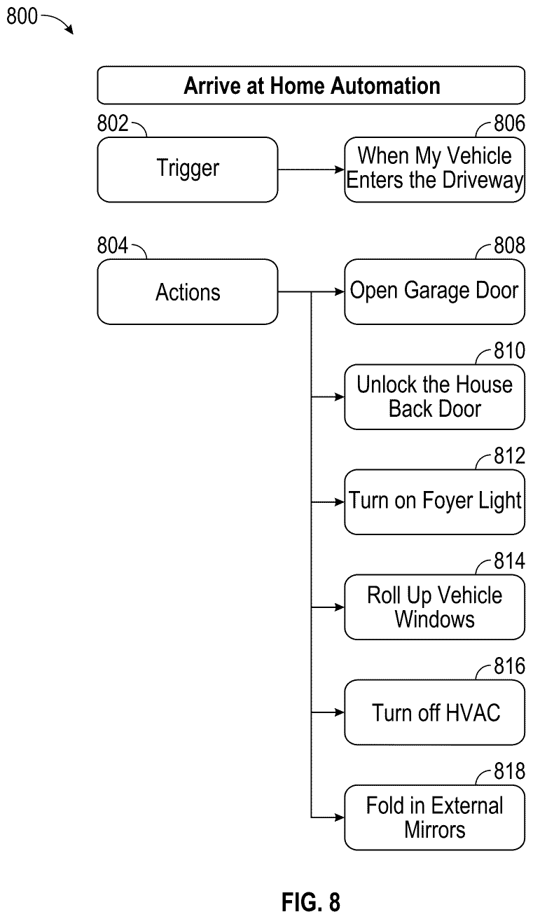

FIG. 3 illustrates a process flow for creating an automation routine according to an embodiment of the present disclosure. At step 302, a user may input information about the automation routine via any of the devices mentioned above. The information may include the name of the automation routine, one or more trigger conditions associated with the automation routine, one or more devices that may execute the automation routine, one or more end devices associated with the automation routine, and one or more actions that are to be performed by the one or more end devices as part of the automation routine. A few examples of automation routines are provided below for explanation with reference to FIGS. 8-11. Once the user inputs the information regarding the automation routines, the user may select to save the automation routine, at step 304, on the device that is being used to create the automation routine. Thereafter, the information about the automation routine is communicated by the device to the automation cloud server (e.g., the automation cloud server 104) at step 306.

Once the automation cloud server receives the information about the automation routine at step 308, the automation cloud server generates a unique automation routine identifier (ARD) for that particular automation routine, at step 310. As mentioned above, the information about the automation routine may include one or more trigger conditions and one or more devices that are assigned to execute the automation routine. The automation cloud server then analyzes the information about the automation routine and associates the various trigger conditions with the appropriate devices and the actions to be taken by that device upon the occurrence of the trigger condition, at step 312. For example, if a trigger condition is the arrival of a particular vehicle at a specific location, then the automation cloud server associates that trigger condition to the particular vehicle. Further, the automation cloud server also associates one or more actions to be taken by the device upon occurrence of the trigger condition. For instance, continuing our above example, once the vehicle arrives at the specific location, the vehicle may automatically unlock all the doors of the vehicle. In another embodiment, the device that generates the automation routine may receive information about available end devices and associated actions, prior to generating the automation routine. The device may then create the necessary associations between the actions, the end devices, and the triggers and send that information to the cloud server. The cloud server may then simply send out the instructions to the end devices without having the knowledge of the association between the end devices, the actions, and the trigger conditions. At step 314, the automation cloud server determines which devices in the automation ecosystem are associated with each automation routine. For instance, an automation routine may involve one or more actions to be taken by a vehicle (e.g., vehicle 102) and a mobile device (e.g., mobile device 112) of the user. In this instance, the automation cloud server may send the details of the automation routine along with the unique automation routine identifier to the vehicle (step 318) and to the mobile device (step 322). In addition, the automation cloud server may also save the automation details and the unique automation routine identifier in a memory of the automation cloud server (step 316).

After the vehicle receives the details of the automation routine; the vehicle may save the details of the automation routine in its memory at step 320. In an embodiment, the details of the automation routine may be stored in the automation agent module 242 described above. Similarly, after the mobile device receives the details of the automation routine, the mobile device may save the details of the automation routine in its memory at step 324. In an embodiment, the automation cloud server may send the entire automation routine to both the vehicle and the mobile device. In other embodiments, the automation cloud server may only send the portion of the automation routine that is relevant to each of the devices. For example, if the automation routine may include the actions of unlocking the vehicle doors and sending a text message to a particular person, the automation cloud server may send the door unlock details to the vehicle and send the text message details to the mobile device. In an embodiment, each of the devices in the ecosystem 100 may register with the automation cloud server 104 when the device connects with the automation cloud server 104 for the first time. Each device may then send its configuration and capabilities information to the automation cloud server 104. This configuration and capabilities information may be used during the automation routine creation process. For example, if the user assigns a particular action to an end device 116, however, based on the capabilities of the end device 116, the automation cloud server 104 determines that the end device 116 is not capable of performing that action, it may provide a notification to the user (e.g., via the input/output device 114) that the selected end device 116 is incapable of performing that action and/or may additionally suggest another end device 116 that is capable of performing that action and request the user to consider the other end device to be included in the automation routine.

In an embodiment, the information about the one or more trigger conditions and information about the one or more actions to be performed, that is provided during step 302, may be used to determine the one or more primary devices (e.g., the vehicle and/or mobile device) and one or more secondary devices (e.g., a light bulb, garage door controller, a smart thermostat, etc.) that are associated with the one or more primary devices. The automation cloud server may then use the information provided at step 302 to generate unique automation routine identifier at step 310. The automation routine generated at step 312 may include the one or more trigger conditions, the one or more actions, and information about the one or more primary devices.

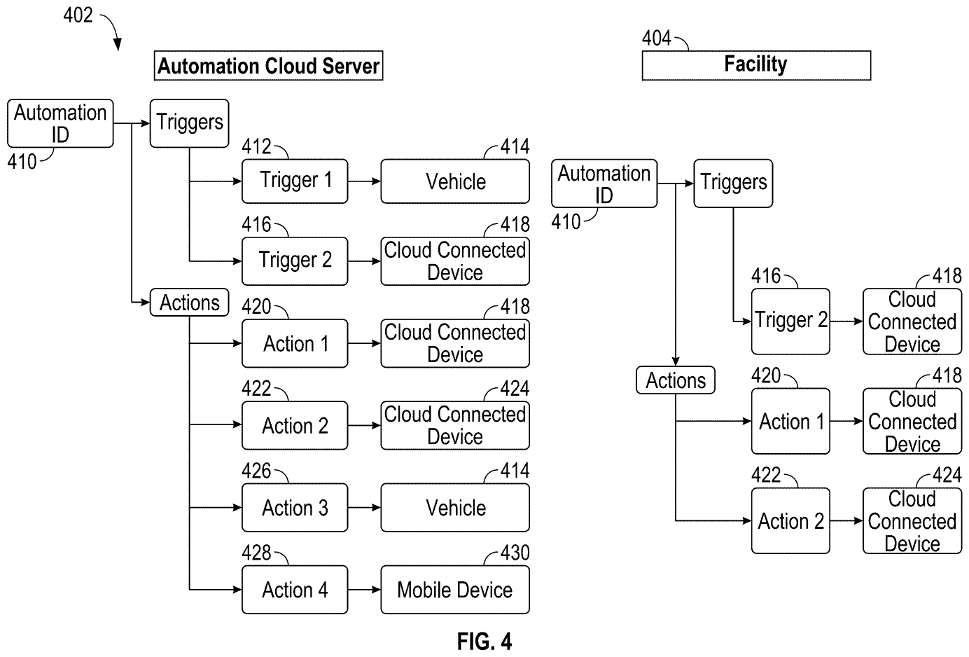

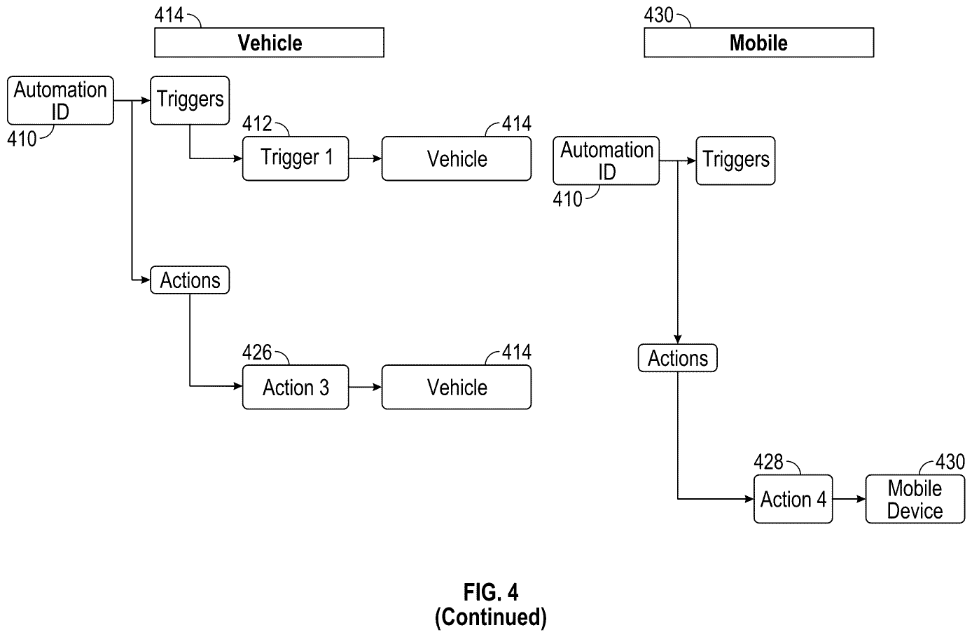

FIG. 4 illustrates an example of an automation routine structure and how each of the devices in the automation ecosystem receives and executes the automation routine according to an embodiment of the present disclosure. At a high level, each automation routine may include information about one or more trigger conditions and one or more actions to be performed by one or more devices upon occurrence of the one or more trigger conditions. A user may create a first automation routine 402 using any of the devices mentioned above. The automation routine 402 may be assigned a unique automation routine identifier 410 by the automation cloud server. As illustrated, the automation routine 402 may be executed upon the occurrence of a first trigger condition 412 and a second trigger condition 416. It is to be noted that a minimum of one trigger condition may be associated with an automation routine. Further, any number of trigger conditions (e.g., one or more) may be associated with an automation routine. Also, any particular device in the ecosystem may be associated with multiple trigger conditions. The example in FIG. 4 illustrates only two trigger conditions. Each of the first trigger condition 412 and the second trigger condition 416 may be associated with a specific device of the ecosystem. In the illustrated example, the first trigger condition 412 is associated with a vehicle 414. For example, the first trigger condition 412 may include the vehicle 414 arriving at a specific location. The second trigger condition 416 is associated with a first device 418 communicably coupled to a facility controller that is situated within a facility (e.g., a home of a user). For example, the second trigger condition 416 may involve the opening of a garage door (i.e., first device 418) of the user's home. As explained above, an automation routine may be associated with one or more trigger conditions. Similarly, execution of the automation routine may be based on occurrence of one or more trigger conditions. For example, the automation routine 402 may be programmed to be executed upon occurrence of the first trigger condition 412, or the occurrence of the second trigger condition 416, or upon occurrence of both the first trigger condition 412 and the second trigger condition 416. Thus, any number of permutations of trigger conditions can be associated with execution of an automation routine.

The automation routine 402 may also include one or more actions to be performed by one or more devices. For instance, the automation routine 402 may include a first action 420 to be performed by a first device 418 associated with the facility 404, a second action 422 to be performed by a second device 424 associated with the facility 404, a third action 426 to be performed by the vehicle 414, and fourth action 428 to be performed by a mobile device 430 of the user. The automation routine 402 may be stored in the memory of the automation cloud server and may also be sent to the vehicle 414 and the facility controller of the facility 404. In an embodiment, the facility 404 may store only the portion of the automation routine that is relevant to the dwelling 404, the vehicle 414 may only store the portion of the automation routine that is relevant to the dwelling 414, and the mobile device 430 may store only the portion of the automation routine that is relevant to the dwelling 430. Moreover, the automation routine 402 may be triggered by any of the facility controller of the facility 404, the vehicle 414, or the mobile device 430. In an embodiment, all of the portions of the automation routine stored by the facility controller of the facility 404, the vehicle 414, and the mobile device 430 are associated with the same automation routine identifier as the main automation routine 402. In this manner, the execution of the automation routine 402 is consistent across all concerned devices in the ecosystem.

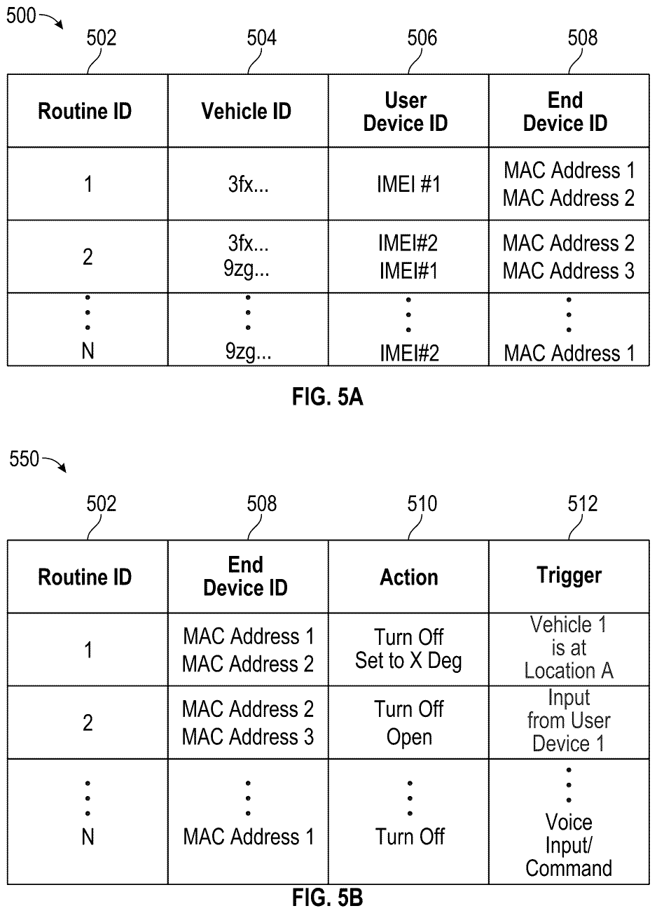

FIGS. 5A and 5B illustrate examples of how the automation routine information is stored with the ecosystem devices according to an embodiment of the present disclosure. FIG. 5A illustrates an example table 500 that may include details of the vehicle and the devices that are associated with a particular automation routine. For instance, an automation routing having an identifier 1 may be associated with a particular vehicle ID 504, a user device ID 506, and one or more end devices IDs 508. In an embodiment, the vehicle ID may include one or more of: Vehicle Identification Number (VIN), License Plate Number, MAC Address, IMEI Number, RFID Tag, Public Key Infrastructure (PKI) Certificate, Blockchain-based Vehicle ID, or the like. The vehicle ID 504 may be used to determine whether a trigger condition is met and also for informing a particular vehicle to execute an automation routine. The user device ID 506 may include a phone number, an IMEI number, a trusted platform module, a secure enclave/trusted execution environment ID, a MAC address, a universally unique identifier (UUID), advertising ID, unique device identifier (UDID), an android ID, PKI certificate, or a cloud device ID associated with the user device. As noted above, a user device may be a mobile device or portable device associated with the user. Similarly, each of the end devices may be uniquely identified using an end device ID 508. The end device ID 508 may be similar to the user device ID 506. The end device ID is used to send instructions to the end device to perform a specific action as part of executing the automation routine. As an example, automation routine having the automation routine ID 1 is associated with (i) a vehicle having a vehicle ID that may include a vehicle identification number (VIN), (ii) a user device having a user device ID that may include IMEI #1, and (iii) two end devices having end device IDs as MAC address 1 and MAC address 2.

FIG. 5B illustrates a table 550 that may include association information between an automation routine ID 502, and end device ID 508, an action 510 associated with the end device, and a trigger condition 512. As illustrated, the table 550 specifies which specific end device 508 will perform what specific action 510, and what the trigger condition(s) 512 are that will cause the execution of the automation routine. For example, an automation routine with ID 1 may be triggered when a vehicle 1 is at a particular location A. As part of the execution of the automation routine, a first end device (e.g., a light bulb) having MAC address 1 may be turned on and a second end device (e.g., a thermostat) having MAC address 2 may be set to x degrees. It is to be noted that FIGS. 5A and 5B are exemplary and one of ordinary skill in the art will realize that there are various other ways in which the information about the automation routines can be stored. All of those ways of storing the automation routine information are within the scope of the disclosure.

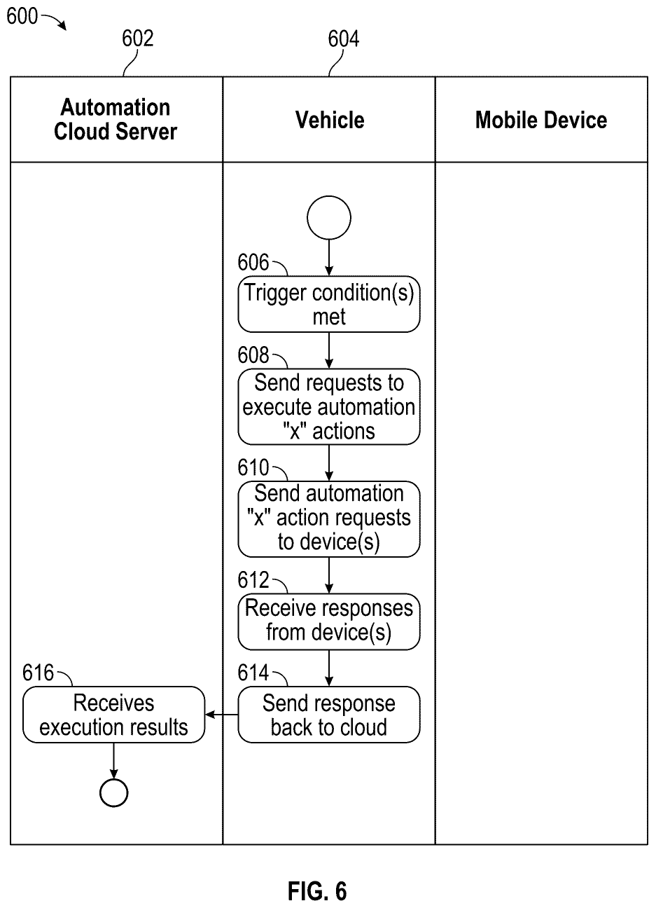

FIG. 6 illustrates a flow diagram for a process 600 for executing an automation routine according to an embodiment of the present disclosure. FIG. 6 illustrates an example in which a vehicle 604 (e.g., vehicle 102 of FIG. 1) executes an automation routine. At step 606, the vehicle may determine (e.g., using the automation agent module 242) that a trigger condition is satisfied. The trigger condition may be satisfied based on some action performed by the vehicle 604 or some event associated with one or more other devices of the automation ecosystem. Once it is determined that the trigger condition is satisfied, the vehicle may send one or more requests to execute the automation routine associated with that trigger condition. For instance, the vehicle may send the automation routing identifier associated with the automation routine to the automation cloud server 602. Since, in this instance, the automation routine fully resides within the vehicle, the automation cloud server 602 may be not send the automation routine identifier to any other device in the automation ecosystem. Since the vehicle knows the automation routine identifier, it can start executing the automation routine. As part of executing the automation routine, the vehicle 604 may send instructions to one or more devices/components associated with the vehicle to perform the specific actions prescribed in the automation routine at step 610. For example, the vehicle 604 may send one request to the window controller of the vehicle to close all the windows of the vehicle. The vehicle may send another request to the climate control system of the vehicle to turn off the air conditioner of the vehicle, etc.

Once the instructions are sent to the one or more devices/components of the vehicle 604, the respective devices/components may perform the prescribed action. Once the actions are completed, the respective devices/components may send a response back to the automation agent module of the vehicle, at step 612, indicating that the prescribed actions have been completed. The vehicle 604 may then send/forward those responses to the automation cloud server 604 indicating that the automation routine has been executed successfully. The automation cloud server 604 receives the information from the vehicle 604 at step 616 and makes a note of the successful completion of the automation routine. In some embodiments, the automation cloud server may provide a notification to the user, via the user device 112, that the automation routine was completed successfully.

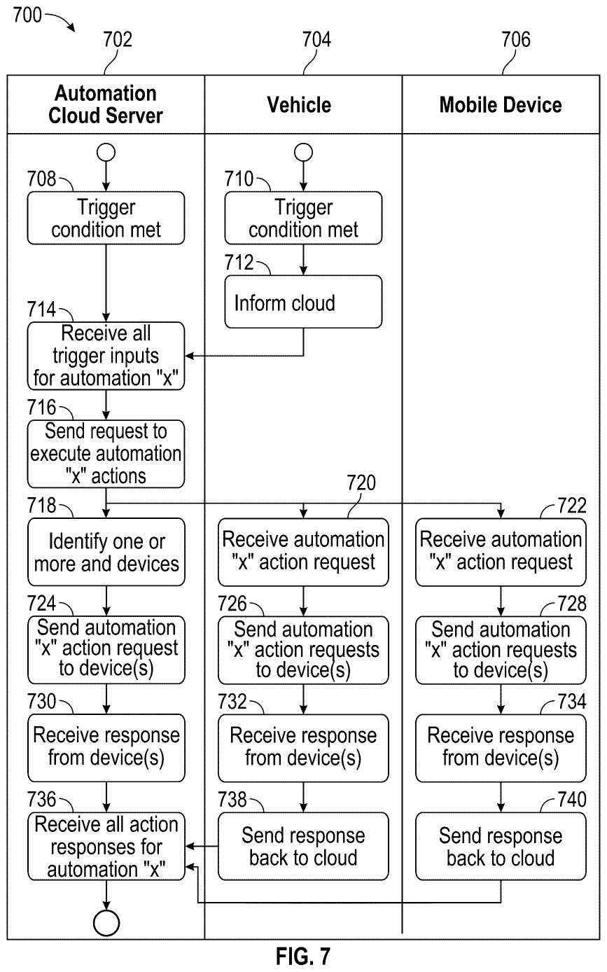

FIG. 7 illustrates a scenario in which multiple devices may act as trigger devices and the automation routine is executed by multiple devices of the ecosystem according to another embodiment of the present disclosure. As used herein, a “trigger device” is the device that may either perform the action that constitutes the trigger condition and/or detect the occurrence of the trigger condition. As illustrated in FIG. 7, an automation routine 700 is executed by the automation cloud server 702, a vehicle 704 (e.g., the vehicle 102 of FIG. 1), and a mobile device 706 (e.g., mobile device 112 of FIG. 1). In this example, the automation routine requires two trigger conditions to be met in order to be executed. At step 708, the automation cloud server 702 may detect that a first trigger condition is satisfied. In addition, the vehicle 704 may detect, at step 710, that a second trigger condition is satisfied. In an embodiment, the first trigger condition and the second trigger condition may be satisfied concurrently or within a specified time of each other. In this instance, the automation cloud server acts as the central location from which the automation routine is launched, although that need not be the case. Accordingly, the vehicle may send a message to the automation cloud server, at step 712, informing the automation cloud server that the second trigger condition is met. At step 714, the automation cloud server receives information about all the trigger conditions that are met and determines whether there is any automation routine associated with the first and the second trigger conditions being met. At step 716, the automation cloud server may identify the automation routine identifier associated with the first trigger condition and the second trigger condition. The automation cloud server may then send the automation routine identifier to the devices associated with that automation routine identifier. In this instance, the automation routine identifier is associated with the automation cloud server 702 the vehicle 704 and the mobile device 706. Thus, at step 716, the automation routine identifier is sent to the vehicle 704 and the mobile device 706

At step 720, the vehicle receives the automation routine identifier. The vehicle 704 has the details of the automation stored in its local memory. The vehicle uses the automation routine identifier to determine the one or more actions it needs to perform as part of the automation routine. Once the one or more actions are identified, the vehicle (e.g., the automation agent module 242) may send instructions to the one or more end devices of the vehicle, instructing those end devices to perform those actions (step 726). At step 732, the vehicle (e.g., the automation agent module 242) may receive a response from each of the end devices about completion of the action by the respective end device. The vehicle may consolidate the responses from all of its end devices and send those responses to the automation cloud server at step 738.

At step 722, mobile device 706 receives the automation routine identifier from the cloud automation server. The mobile device 706 has the details of the automation routine stored in its local memory. The mobile device 706 may use the automation routine identifier to determine the details of the automation routine associated with that automation routine routing identifier. Thereafter, the mobile device may send instructions, at step 728, to one or more of its components (i.e., end devices) instructing the components to perform the actions associated with the automation routine. At step 734, the mobile device 706 may receive responses from its one or more components about the successful execution of the automation routine. The mobile device 708 may then send that information to the automation cloud server 702, at step 740.

At step 718, the automation cloud server 702 may determine one or more end devices that are controllable by the automation cloud server and that are associated with the automation routine identifier. The automation cloud server 702 may then send instructions to one or more of the end devices that it controls, at step 724. Once the one or more end devices perform the specified actions, they may send a response back to the automation cloud server 702 indicating successful completion of the actions. The automation cloud server 702 may receive the responses from the one or more end devices at step 730. The automation cloud server 702 receives information about successful completion of the automation routine via the various devices and consolidates that information at step 736. If all the actions associated with the automation routine are successfully completed, the automation cloud server 702 may send a notification indicative of the successful completion of the automation routine to the vehicle 702, the mobile device 706 or both.

FIG. 8 illustrates an example of an automation routine 800 according to an embodiment of the present disclosure. The automation routine is associated with a single trigger condition 802 and multiple actions 804. In other words, the occurrence of the single trigger condition 802 may begin the execution of the automation routine 800. In the specific example illustrated, the automation routine 800 may include a trigger condition 802 that specifies an action/event 806. The occurrence of the action/event 806 results in the trigger condition 802 being satisfied. As shown, the action 806 in this instance is that the vehicle of the user arrives at a specific location (e.g., the driveway of his house). A confirmation of the occurrence of the action/event can be determined or detected either by the vehicle itself, or by a facility controller associated with the user's home, or by a mobile device of the user. For example, the vehicle or the mobile device may determine, based on their respective current GPS locations, that the vehicle is at a location that matches the location of the user's home. The automation routine 800 specifies multiple actions 804 that are to be performed upon the trigger conditions being satisfied. These actions include opening the garage door (808), unlocking the house back door (810), turning on the foyer light (812), rolling up the vehicle windows (814), turning off the vehicle climate control (816), and folding the vehicle's external mirrors (818). As can be seen, some of the actions are to be performed by the vehicle and some of the actions are to be performed by one or more devices located in the home. The set of actions associated with each automation routine can be grouped into one or more groups depending on which end device will need to perform that particular action. In this instance, actions 808, 810, and 812 may be performed by end devices in the house, and actions 814, 816, and 818 may be performed by the vehicle via one or more of its sub-systems. As explained above, once this automation routine is created, it will be assigned a unique automation routine ID, and that information will be stored in the automation cloud server. The automation routine 800 may then be propagated to other devices in the automation ecosystem. In this instance, since the actions are to be performed by end devices in the house and the vehicle, the automation routine 800 will be propagated to the facility controller associated with the house and to the vehicle. The automation cloud server may also store a copy of the automation routine 800. In other embodiments, the automation cloud server may only store the automation routine identifier and not the details of the automation routine 800. This may be done where more privacy is needed, or the local rules and regulations require the data to be stored locally on edge-computing devices.

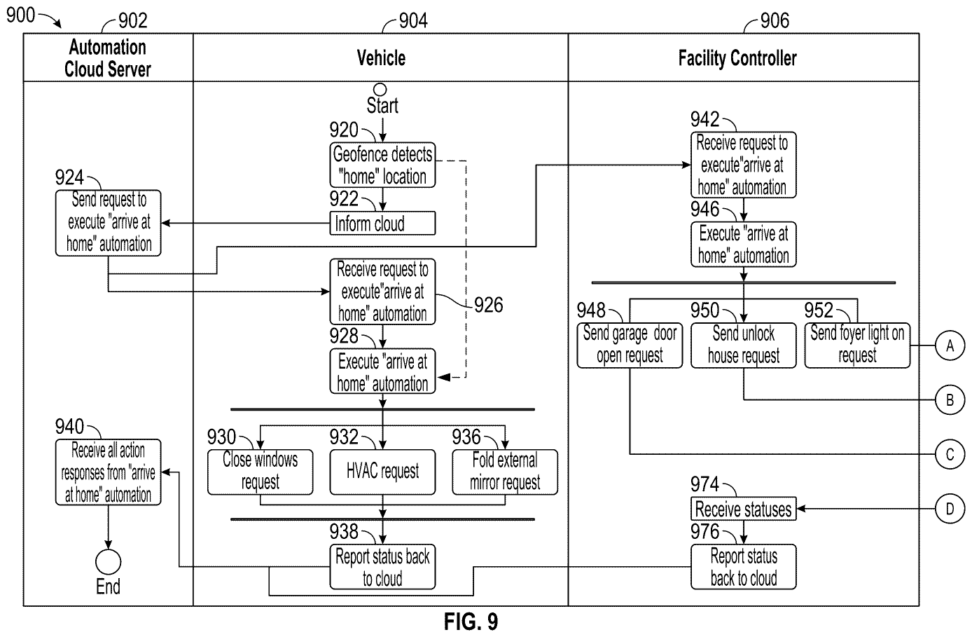

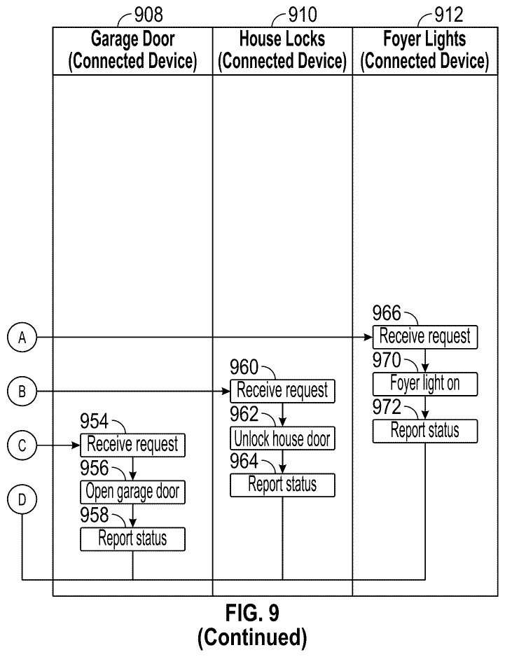

FIG. 9 illustrates a process 900 for executing the automation routine 800 according to an embodiment of the present disclosure. The process 900 starts with the vehicle 904 detecting the occurrence of the trigger condition 802 at step 920. For instance, the vehicle may determine based on its current location that it is on the driveway of the user's home. At step 922, The vehicle may send a message to the automation cloud server 902 informing the automation cloud server 902 that the trigger condition 802 has been met. Upon receiving the message from the vehicle 904, the automation cloud server 902 may identify the automation routine identifier associated with that trigger condition and send that information, concurrently or sequentially, to the facility controller 906 and the vehicle 904, at step 924. As noted above, both the vehicle and the facility controller have the details of the automation routine 800 stored on their respective local memory. At step 926, the vehicle receives the automation routine identifier from the automation cloud server 902 and begins executing the automation routine 800, at step 928. At step 930, the vehicle may operate its windows and close all the windows. At step 932, the vehicle may turn off the climate control of the vehicle, and at step 936, the vehicle may fold the exterior mirrors, as specified in the automation routine 800. Once the vehicle 904 has completed all of its actions associated with the automation routine 800, the vehicle may send a message to the automation cloud server 902, at step 938, informing the automation cloud server of successful completion of the actions 814, 816, and 818. The automation cloud server 902 may receive the message from the vehicle, at step 940.

The facility controller 906 may receive the automation routine identifier from the automation cloud server 902, at step 942. The controller then identifies the automation routine 800 based on the automation routine identifier and begins executing the automation routine 800 at step 946. At step 948, the facility controller 906 sends a request to a garage door opener (i.e., an end device) 908 to open the garage door. At step 950, the facility controller 906 sends an unlock request to a smart lock 910 associated with a back door of the house. At step 952, the facility controller 906 sends a request to a foyer light 912 to turn the foyer light on. At step 954, the garage door opener receives the request from the facility controller, opens the garage door at step 956, and reports the opening of the garage door to facility controller at step 958. At step 960, the smart lock receives the request from the facility controller, performs an unlock action at step 962, and reports successful completion of the unlock action to the facility controller 906 at step 964. At step 966, the foyer light may receive the “turn on” request from the facility controller, turn on the foyer light at step 970, and report the current status of the foyer light to the facility controller at step 972. At step 974, the facility controller consolidates the status updates from the garage door opener 908, the smart lock 910, and the foyer light 912. At step 976, the facility controller 906 sends all the status updates to the automation cloud server 902. The automation cloud server consolidates all the status updates received from the vehicle 904 and the facility controller 906 at step 940 and records successful execution of the automation routine 800. In some embodiments, the automation cloud server 902 may send a notification to one or more user devices notifying the user about the successful completion of the automation routine 800. In some embodiments, steps 922 and 926 can be optional and may not be needed. Instead, the vehicle 904 may directly execute the step 928 after step 920.

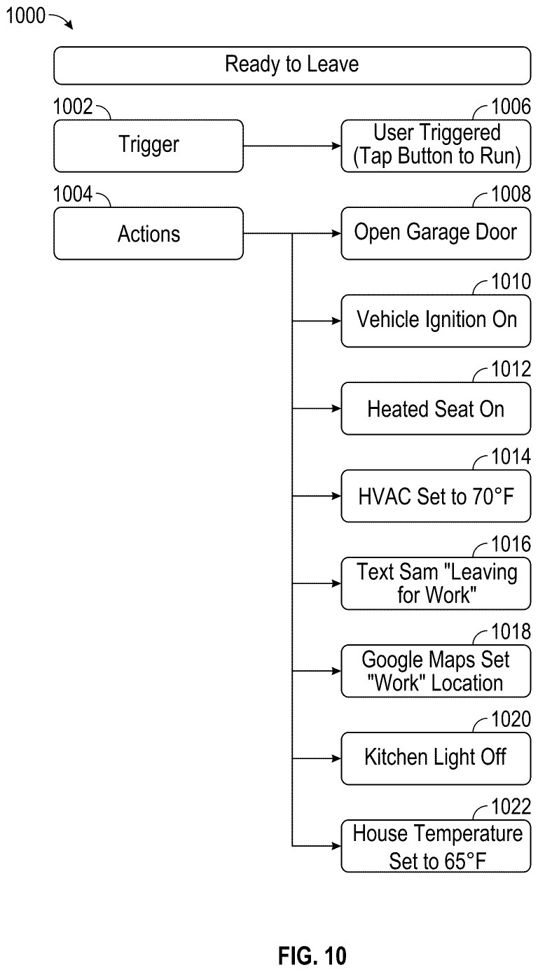

FIG. 10 illustrates an automation routine 1000 according to another embodiment of the present disclosure. The automation routine 1000 may include one trigger condition 1002 and an action/event 1006 associated with the trigger condition 1002. The trigger condition 1002 is satisfied when the action 1006 is performed by a mobile device associated with the user. In this instance, the action is the user manually activating the automation routine (e.g., by selecting a control on the mobile device). The automation routine 1000 may include several actions 1004 associated with it. For example, the actions 1000 include opening the garage door (1008), turning on the vehicle ignition 1010, turning on the heated seat of the vehicle 1012, turning on the climate control system of the vehicle and setting to a temperature 1014, texting a specific person 1016, setting a navigation function 1018, turning off the kitchen light 1020, and setting the house temperature to a set point 1022. The automation routine will be executed when the trigger condition 1002 is met. As can be seen, the actions 1004 include actions to be performed by the vehicle, the mobile device, and a facility controller of the user's home.

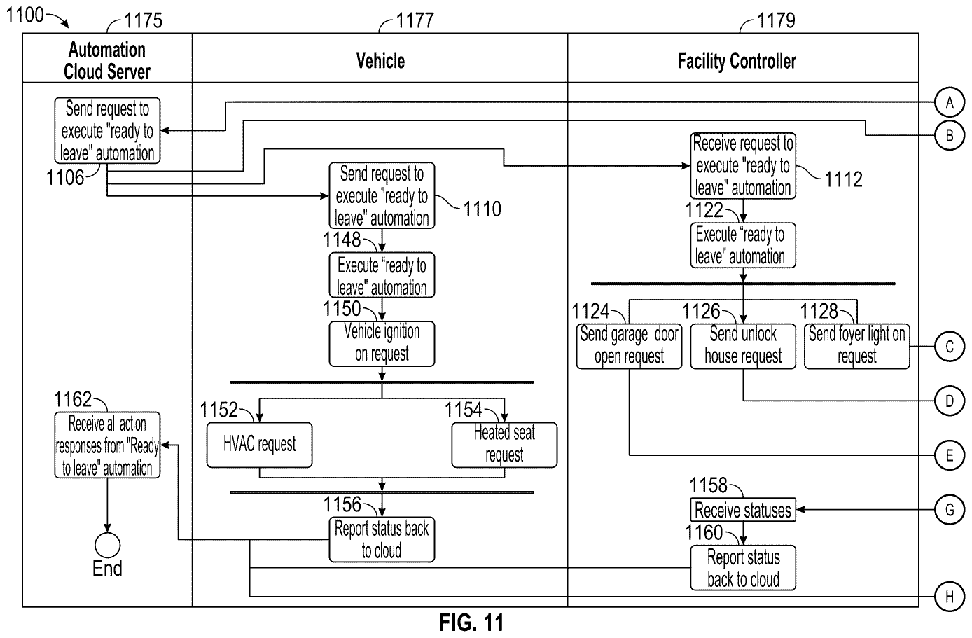

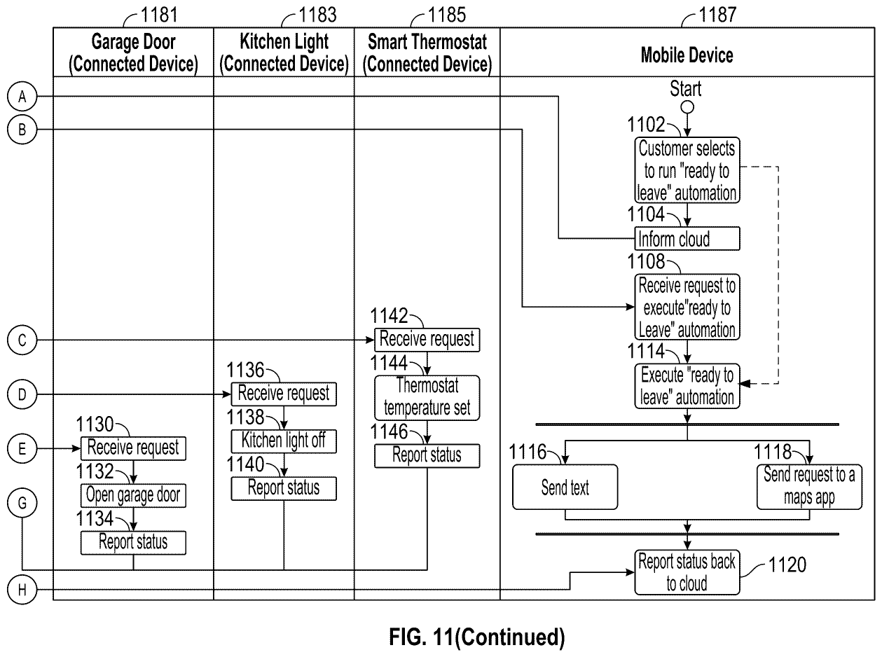

FIG. 11 illustrates a process flow 1100 for executing the automation routine 1000 according to an embodiment of the present disclosure. In this instance, the device responsible for satisfying the trigger condition is the user's mobile device 1187. At step 1102, the user may operate a control input on the mobile device 1187 to run the automation routine 1000. The mobile device 1187 may then send a message to the automation cloud server 1175 regarding selection of the automation routine 1000, at step 1104. At step 1106, the automation cloud server 1175 receives the information from the mobile device and sends the automation routine identifier associated with the automation routine 1000 to the vehicle 1177, at step 1110, the facility controller 1179, at step 1112, and/or the mobile device 1187, at step 1108. At step 1114, the mobile device determines the details of the automation routine 1000 based on the automation routine identifier and starts execution of the automation routine 1000. In some embodiments, the mobile device 1187 need not wait to receive the automation routine identifier from the automation cloud server 1175 and may start execution of the automation routine 1000 after the trigger conditions are satisfied. At step 1116, the mobile device sends a text message to the specified user and at step 1118, the mobile device configures the navigation application. In this manner, the mobile device 1187 completes all of its actions specified in the automation routine 1000. At step 1120, the mobile device reports the completion of its tasks and the current status report to the automation cloud server.

At step 1148, the vehicle 1177 determines the details of the automation routine 1000 based on the automation routine identifier received at step 1110 and begins executing the automation routine 1000. At step 1150, the vehicle turns on the ignition and starts the vehicle. Thereafter, at step 1152, the vehicle 1177 performs the actions related to the climate control system and at step 1154, the vehicle turns on the heated seats. Once all the actions are completed, the vehicle sends a message to the automation cloud server 1175 informing the automation cloud server that all the actions have been completed (step 1156).

At step 1122, the facility controller 1179 determines the details of the automation routine 1000 based on the automation routine identifier received at step 1112 and begins executing the automation routine 1000. The facility controller 1179 sends a request to a garage door opener 1181 to open the garage door (step 1124), sends a request to a kitchen light 1183 to turn on (step 1126), and sends a request to a smart thermostat 1185 (step 1128). The garage door opener 1181 receives the request at step 1130, opens the garage door at step 1132, and reports its status to the facility controller at step 1134. Similarly, concurrently or sequentially, the kitchen light 1183 receives the request from the facility controller at step 1136 and then turns on the kitchen light (step 1138) and reports a status to the facility controller (step 1140). Concurrently or sequentially, the smart thermostat 1185 receives the request from the facility controller at step 1142. Thereafter, the smart thermostat adjusts to the prescribed temperature (step 1144) and reports the status of the smart thermostat to the facility controller (step 1146). The facility controller consolidates the status reports from the kitchen light 1183, garage door opener 1181, and the smart thermostat 1185, at step 1158 and sends the status report to the automation cloud server, at step 1160. The automation cloud server consolidated all the status reports received from the vehicle 1177, the facility controller 1179, and the mobile device 1187, at step 1162. The automation cloud server may then store the status reports and determine that the automation routine 1000 has been executed successfully. In an embodiment, the automation cloud server may send a notification to the mobile device 1187 informing the user of the successful completion of the automation routine 1000. In this instance, the kitchen light 1183, garage door opener 1181, and the smart thermostat 1185 are the end device (e.g., end devices 114 of FIG. 1). In some embodiments, steps 1104 and 1108 can be optional. In this instance, the mobile device 1187 may directly perform step 1114 after step 1102 since the mobile device 1187 already knows the automation routine that needs to be executed.

FIG. 12 depicts a block diagram of an example automation cloud server 1000 (e.g., automation cloud server 104 of FIG. 1) upon which any of one or more techniques (e.g., methods) may be performed or which may perform the methods described above in conjunction with the one or more vehicles 102, in accordance with one or more example embodiments of the present disclosure. In other embodiments, the server 1200 may operate as a standalone device or may be connected (e.g., networked) to other servers. In a networked deployment, the server 1200 may operate in the capacity of a server machine, a client machine, or both in server-client network environments. In an example, the server 1200 may act as a peer server in peer-to-peer (P2P) (or other distributed) network environments. The server 1200 may be a personal computer (PC), a tablet PC, a set-top box (STB), a personal digital assistant (PDA), a mobile telephone, a smart key fob, a wearable computer device, a web appliance, a network router, a switch or bridge, or any machine capable of executing instructions (sequential or otherwise) that specify actions to be taken by that server, such as a base station. Further, while only a single server is illustrated, the term “server” shall also be taken to include any collection of servers that individually or jointly execute a set (or multiple sets) of instructions to perform any one or more of the methodologies discussed herein, such as cloud computing, software as a service (SaaS), or other computer cluster configurations.

Examples, as described herein, may include, or may operate on logic or a number of components, modules, or mechanisms. Modules are tangible entities (e.g., hardware) capable of performing specified operations when operating. A module may include hardware. In an example, the hardware may be specifically configured to carry out a specific operation (e.g., hardwired). In another example, the hardware may include configurable execution units (e.g., transistors, circuits, etc.) and a computer-readable medium containing instructions where the instructions configure the execution units to carry out a specific task when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The server (e.g., computer system) 1200 may include a hardware processor 1202 (e.g., a central processing unit (CPU), a graphics processing unit (GPU), a hardware processor core, or any combination thereof), a main memory 1204 and a static memory 1206, some or all of which may communicate with each other via an interlink (e.g., bus) 1208. The server 1200 may further include a graphics display device 1210, an alphanumeric input device 1212 (e.g., a keyboard), and a user interface (UI) navigation device 1214 (e.g., a mouse). In an example, the graphics display device 1210, alphanumeric input device 1212, and UI navigation device 1214 may be a touch screen display. The server 1200 additionally may include a storage device (i.e., drive unit) 1216, a network interface device/transceiver 1220 coupled to antenna(s), and one or more sensors 1228, such as a global positioning system (GPS) sensor, a compass, an accelerometer, or another sensor. The server 1200 may include an output controller 1234, such as a serial (e.g., universal serial bus (USB)), parallel, or other wired or wireless (e.g., infrared (IR)), near field communication (NFC), etc. connection to communicate with or control one or more peripheral devices (e.g., a printer, a card reader, etc.).

The storage device 1216 may include a machine-readable medium 1222 on which is stored one or more sets of data structures or instructions (e.g., software) embodying or utilized by any one or more of the techniques or functions described herein. The instructions also may reside, completely or at least partially, within the main memory 1204, within the static memory 1206, or within the hardware processor 1202 during execution thereof by the server 1200. In an example, one or any combination of the hardware processor 1202, the main memory 1204, the static memory 1206, or the storage device 1216 may constitute machine-readable media.

While the machine-readable medium 1222 is illustrated as a single medium, the term “machine-readable medium” may include a single medium or multiple media (e.g., a centralized or distributed database, and/or associated caches and servers) configured to store the one or more instructions.

Various embodiments may be implemented fully or partially in software and/or firmware. This software and/or firmware may take the form of instructions contained in or on a non-transitory computer-readable storage medium. Those instructions then may be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as, but not limited to, read-only memory (ROM) random access memory (RAM), magnetic disk storage media, optical storage media, a flash memory, etc.

The term “machine-readable medium” may include any medium that is capable of storing, encoding, or carrying instructions for execution by the server 1200 and that causes the server 1200 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium may include a machine-readable medium with a plurality of particles having resting mass. Specific examples of massed machine-readable media may include nonvolatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions may further be transmitted or received over a communications network using a transmission medium via the network interface device/transceiver 1220 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1220 may include one or more physical jacks (e.g., Ethernet, coaxial, or phone jacks) or one or more antennas to connect to the communications network. In an example, the network interface device/transceiver 1220 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the server 1200 and may include digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

It is to be noted that the vehicle implements and/or performs operations, as described here in the present disclosure, in accordance with the owner's manual and safety guidelines. In addition, any action taken by the vehicle owner/driver based on recommendations or notifications provided by the vehicle should comply with all the rules specific to the location and operation of the vehicle (e.g., federal, state, country, city, etc.). The recommendations or notifications, as provided by the vehicle, should be treated as suggestions, and only followed according to any rules specific to the location and operation of the vehicle. In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more hardware, software, firmware, digital components, or analog components. For example, one or more application-specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name but not function.

It should also be understood that the word “example” as used herein, is intended to be non-exclusionary and non-limiting in nature. More particularly, the word “example” as used herein, indicates one among several examples, and it should be understood that no undue emphasis or preference is being directed to the particular example being described.

A computer-readable medium (also referred to as a processor-readable medium) may include any non-transitory (e.g., tangible) medium that participates in providing data (e.g., instructions) that may be read by a computer (e.g., by a processor of a computer). Such a medium may take many forms, including, but not limited to, nonvolatile media and volatile media. Computing devices may include computer-executable instructions, where the instructions may be executable by one or more computing devices, such as those listed above, and stored on a computer-readable medium.

With regard to the processes, systems, methods, heuristics, etc., described herein, it should be understood that, although the steps of such processes, etc., have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined not with reference to the above description but should instead be determined with reference to the appended claims, along with the full scope of equivalents to which such claims are entitled. It is anticipated and intended that future developments will occur in the technologies discussed herein and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
determining that one or more trigger conditions are satisfied, wherein the one or more trigger conditions are associated with an automation routine;
determining, based on the one or more trigger conditions being satisfied, an automation routine identifier associated with the automation routine;
sending the automation routine identifier to one or more primary devices;
determining, by the one or more primary devices and using the automation routine identifier, one or more actions associated with the automation routine;
operating, by the one or more primary devices and based on the one or more actions, one or more secondary devices communicably coupled to the one or more primary devices; and
receiving, from the one or more primary devices, a status update associated with execution of the automation routine.

2. The method of claim 1, wherein the automation routine is stored in a local memory of each of the one or more primary devices.

3. The method of claim 1, wherein the one or more trigger conditions include a first trigger condition and a second trigger condition and wherein determining that one or more trigger conditions are satisfied further comprises one of:
the first trigger condition being satisfied or the second trigger condition being satisfied; or
the first trigger condition being satisfied and the second trigger condition being satisfied.

4. The method of claim 1, wherein the one or more primary devices include a first primary device and a second primary device, and wherein the one or more actions include:
a first set of actions associated with the first primary device; and
a second set of actions associated with the second primary device.

5. The method of claim 1, further comprising:
receiving information about the one or more trigger conditions;
receiving information about the one or more actions;
determining, based on the one or more actions, the one or more primary devices;
generating the automation routine identifier;
generating the automation routine; wherein the automation routine includes the one or more trigger conditions, the one or more actions, and information about the one or more primary devices; and
assigning the automation routine identifier to the automation routine.

6. The method of claim 1, wherein the one or more trigger conditions are associated with the one or more primary devices.

7. The method of claim 1, wherein the one or more primary devices include an automation cloud server, a vehicle, a facility controller, or a mobile device associated with a user.

8. The method of claim 7, wherein the one or more secondary devices include:
a first set of devices within the vehicle and controllable by the vehicle;
a second set of devices located within a facility and controllable by the facility controller;
a third set of devices controllable by the automation cloud server; and
a fourth set of devices controllable by the mobile device.

9. A method comprising:
receiving information about one or more trigger conditions;
receiving information about one or more actions;
determining, based on the one or more actions, one or more primary devices;
determining, based on the one or more actions, one or more secondary devices, wherein the secondary devices are associated with the one or more primary devices;
generating an automation routine identifier;
generating an automation routine, wherein the automation routine includes the one or more trigger conditions, the one or more actions, and information about the one or more primary devices;
assigning the automation routine identifier to the automation routine; and
sending the automation routine to the one or more primary devices.

10. The method of claim 9, further comprising:
receiving information that the one or more trigger conditions are satisfied;
sending the automation routine identifier to the one or more primary devices;
determining, by the one or more primary devices, the automation routine based on the automation routine identifier; and
executing, by the one or more primary devices, the automation routine.

11. The method of claim 10, wherein executing the automation routine further comprises:
sending, by the one or more primary devices, one or more instructions to the one or more secondary devices; and
causing, by the one or more primary devices and based on the one or more instructions, the one or more secondary devices to perform the one or more actions.

12. The method of claim 11, further comprising:
receiving, by the one or more primary devices and in response to sending the one or more instructions, status information from the one or more secondary devices; and
sending, by the one or more primary devices, to an automation cloud server, the status information.

13. The method of claim 9, wherein the one or more primary devices include an automation cloud server, a vehicle, a facility controller, or a mobile device associated with a user.

14. The method of claim 13, wherein the one or more secondary devices include:
a first set of devices within the vehicle and controllable by the vehicle;
a second set of devices located within a facility and controllable by the facility controller;
a third set of devices controllable by the automation cloud server; and
a fourth set of devices controllable by the mobile device.

15. A system comprising:
a first device;
a second device communicably coupled to the first device;
one or more third devices communicably coupled to the first device or the second device; and
a memory device that stores instructions, which when executed by a processor of the first device, cause the processor to:
determine that one or more trigger conditions are satisfied, wherein the one or more trigger conditions are associated with an automation routine;
determine, based on the one or more trigger conditions being satisfied, an automation routine identifier associated with the automation routine;
send the automation routine identifier to the second device;
cause the second device to perform a first set of actions associated with the automation routine;
perform a second set of actions associated with the automation routine; and
receive, from the second device, a status update associated with execution of the automation routine.

16. The system of claim 15, wherein to perform a second set of actions associated with the automation routine, the processor sends one or more instructions to the one or more third devices.

17. The system of claim 15, wherein the first device or the second device is one of: a vehicle, a user mobile device, an automation cloud server, or a facility controller located within a facility.

18. The system of claim 17, wherein the one or more third devices include:
a first set of devices within the vehicle and controllable by the vehicle;
a second set of devices located within a facility and controllable by the facility controller;
a third set of devices controllable by the automation cloud server; and
a fourth set of devices controllable by the user mobile device.

19. The system of claim 15, wherein the processor is further configured to:
receive information about the one or more trigger conditions;
receive information about the first set of actions;
determine, based on the first set of actions, the second device;
generate the automation routine identifier;
generate the automation routine, wherein the automation routine includes the one or more trigger conditions and the first set of actions; and
assign the automation routine identifier to the automation routine.

20. The system of claim 19, wherein the processor is further configured to send the automation routine to the second device.
